(19) United States
(12) Patent Application Publication
(10) Pub. No.: US 2006/0201122 A1
(43) Pub. Date: Sep. 14, 2006

(54) Mowing device

(76) Inventor: Eldon William Bishop, Murfreesboro, TN (US)

Correspondence Address: ELDON WILLIAM BISHOP, 9033 SHELBYVILLE HIGHWAY, BELL BUCKLE, TN, 37020, US

(21) Appl. No.: 10/720,637

(22) Filed: Nov. 4, 2004

(51) Int. Cl. A01D 34/00

(52) U.S. Cl. 56/15.6

(57) ABSTRACT

A device that is a fully self-contained motorized mowing apparatus with an electric-clutch. It is in tow behind self-propelled mowing equipment. A tow hitch frame is attached above and to the carrier frame, back of center of the mower carrier frame. Front wheels are stationary and rear wheels pivot, allowing the mower to follow directly off to the side of the lead equipment. Towing more specifically to “zero turn” tow units without leaving an uncut strip of turf.

### BACKGROUND OF THE INVENTION

1. Field of Invention

The invention relates to mowing machinery towed and used in conjunction with other machinery to cut and/or increase the cutting width of other mowing machinery.

2. Prior Art

Commercial and Industrial Maintenance organizations are constantly trying to increase the cutting capacity of their existing mowing machinery. Specifically in the commercial mower industry, users utilizing the “zero turn” mowers can double their mowing performance by attaching a side wing mower.

Using wing mowers that are currently on the market where the front wheels pivots and the rear wheels remain rigid does not work well because it leaves a cut strip of grass in the turns. But, by having the font wheels rigid and the back wheels pivoting is not the total solution. The towing device must hook to the center of the pivot of the mower or it will list and will not tow correctly. So the hitch must be put in the center of the mower carriage and must be put back of center of the front of the mower or the front wheels will slide and not trail in proper relation to the “zero turn” machine.

### SUMMARY OF THE INVENTION

The invention provides for a fully self-contained mower machine having its own reciprocating air-cooled engine. Attached to the engine is an electro-clutch for positive engagement of the three blades and a adjustable backside idler is used to keep the belt tight on the bearing housing pulleys. Incorporating a carrying frame for carrying the deck and motor allows the mower device to be extremely maneuverable. It can be towed up to 8 mph while mowing. The carrier frame has three height adjustments for setting the cutting height of the mowing deck. Further included on said carrier frame are rigid front wheels, swivel mounted rear wheels and center mounted steering yokes connected mid-way back on the carrier frame to help create the zero turn. The steering yokes are also connected toward the front of the carrier frame and the front of the deck to the offset tow bar, which is paramount in making the zero turn. It is important to understand that if the steering yokes are not mounted to the center of the carrier frame not only will it not stay square when it is being towed but also it will not turn correctly. It is likely to slide instead of making the turn and the steering becomes sluggish at best.

It is to be understood that this mowing machine is intended to be used while being towed by another mowing machine with its own cutting deck.

### DESCRIPTION OF DRAWINGS

FIG. 1 on page 1 is a Front Elevation View of the carrier frame, deck with anti-scalp rollers and view of the three height adjusters on the carrier frame; it also shows the motor mount bracket between the top of the deck and the bottom of the carrier frame.

FIG. 2 on page 2 is a Top Plane View of the cutting deck, the carrier frame, the steering yokes mounted to the center of the carrier frame and attached to the offset tow bar.

FIG. 3 on page 3 is a Right Side Elevation View and shows the carrier frame, rear height adjuster, rigid front wheels, to the left and swivel mounted rear wheels to the right.

FIG. 4 is an Isometric View that shows the completed assembly.

### GENERAL INFORMATION

A mowing device is shown in FIG. 2 which embodies several of the features of the invention. The mowing device in FIG. 2 includes a carrier frame (1) used as the means to support and transport the mowing deck (2) which houses all of the bearing housing assemblies and pulleys used to propel the blades which do the actual cutting. A mowing deck (2) is attached to the carrier frame (1) by use of two drag bar linkages (3) on either side of the carrier frame (1) and to brackets (4) welded directly on the top and to the front of the cutting deck (2). Also attached to the two front brackets (4) are two height adjustment cranks (5) used to raise, lower and level the front of the mowing deck (2). To the rear of the mowing deck (2) illustrated in FIG. 3 is the rear height adjustment bracket (6) used to raise and lower the back of the deck by means of the rear height adjustment crank (7) which is attached to the rear tube brace (8) illustrated in FIG. 2. This rear tube brace (8) is used to reinforce the carrier frame (1) visible in FIG. 2. Also attached are the rear mounted swivel wheels (9) shown in FIG. 3 mounted on rear of the left and right extensions of carrier frame (1) and are used to support the rear of the mower.

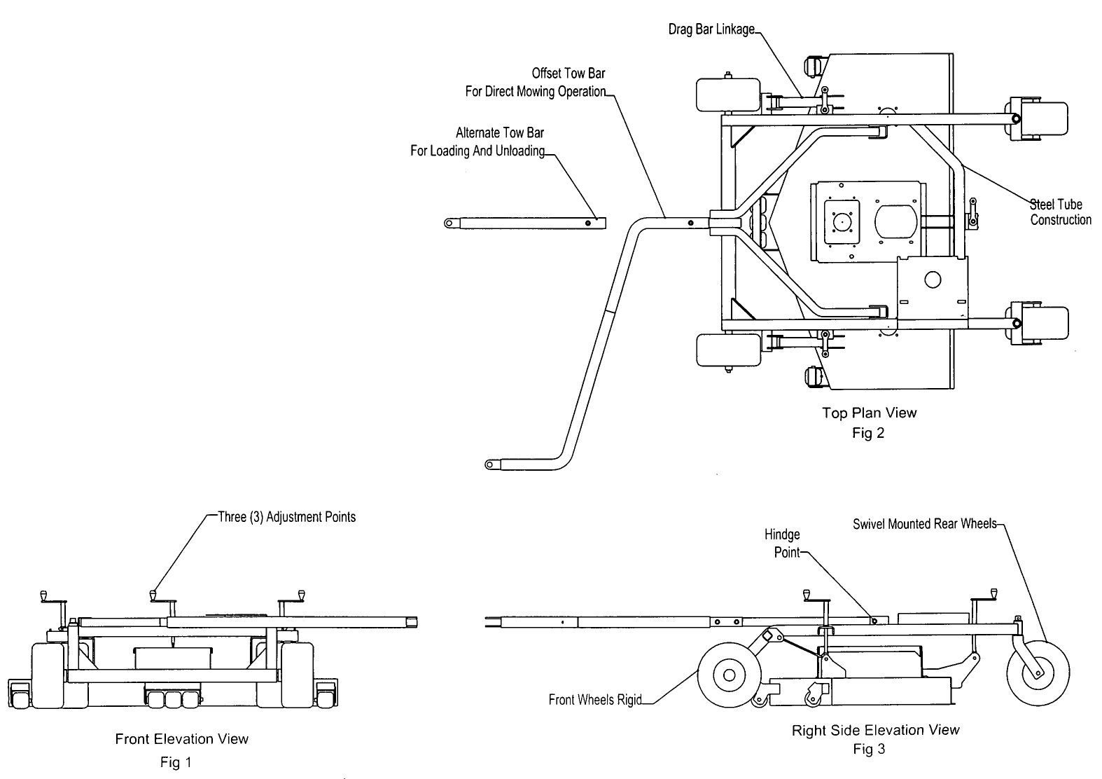

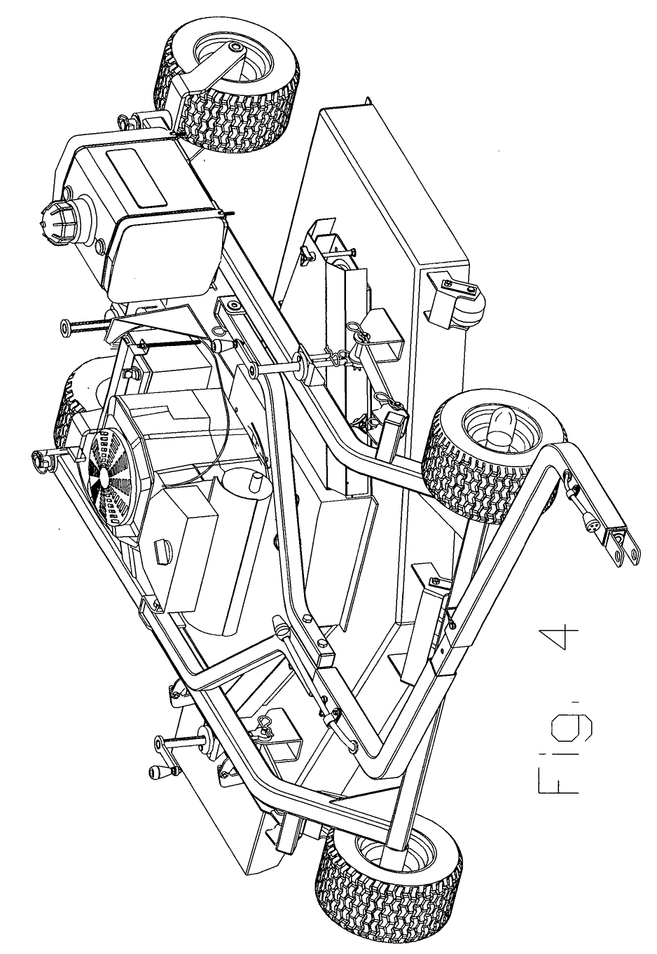

Also mounted to the left and right carrier frame (1) shown in FIG. 2 and to the front of the left and right beams (10) are the rigid front wheels (11) which support the front of the mower deck (2). The rigid front wheels (11) are attached to the carrier frame (1) by an axle (12) that is mounted to the front support channel (13) FIG. 1 that is welded to the left and right extensions of support beams (10) and are reinforced by gussets (14) welded to the front support channel (13) and to the left and right support beams (10). As the rigid front wheels (10) do not swivel and the offset tow bar (15) maneuvers into a sharp turn by a tow vehicle (not shown) the rigid front wheels (11) become the fulcrum that starts the turn by the rear swivels wheels (9). It is possible that in extremely sharp turns the rigid front wheels (10) will counter rotate as the mower machine does a complete zero turn. It must be noted that the other main contributing factor for the machine to make a zero turn is that the steering yokes (16) FIG. 2 are located back of center on the support beams (10) which helps prevent the front wheels from slipping and by location contributes in making the turn. It is important to understand that if the steering yokes are not mounted to the center of the carrier frame, not only will it not stay square when it is being towed but also it will not turn correctly. It is to be noted that by making the front wheels rigid (10) and the rear wheels (9) swivel in the rear of the device, that when towed on the right side of a zero turn machine the left front rigid wheel (10) will usually track just to the right of the zero turn machine's right rear wheel eliminating uncut strip of turf. The offset tow bar (15) is adjustable to accommodate different width size tow-machine decks.

I claim:

1. A fully self-contained motorized mowing machine.
a Attachment frame attaches above and to the center of the mower carrier frame and pivots vertically.
b A main rigid tow bar that is bent in such a manner as to offset the mower to the side of the towing machine towing first said frame unit.
c Stationary front wheels that when turned forces the said frame to be turned by the rear wheels.
d This steering from the center of said first frame with rigid front wheels and the rear wheels swiveling assures that there will be no uncut strip of grass.
